(19) United States
(12) Patent Application Publication
(10) Pub. No.: US 2015/0036061 A1
(43) Pub. Date: Feb. 5, 2015

(54) DISPLAY DEVICE

(71) Applicant: HengHao Technology Co. LTD, Taoyuan County (TW)

(72) Inventor: Chun-Jung CHEN, Taoyuan County (TW)

(73) Assignee: HengHao Technology Co. LTD, Taoyuan County (TW)

(21) Appl. No.: 13/966,076

(22) Filed: Aug. 13, 2013

(30) Foreign Application Priority Data
Aug. 5, 2013 (TW) 102128008

(51) Int. Cl. G06F 1/16; F21V 9/00

(52) U.S. Cl. CPC G06F 1/1643; F21V 9/00
USPC 349/12; 362/311.13

(57) ABSTRACT

A display device includes a decoration layer, which is at least formed in at least a portion of a view area. When a display module operates to emit light through the decoration layer, the decoration layer appears to be transparent; when the display module does not operate, the decoration layer is irradiated by ambient light to reveal a decorative pattern of the decoration layer.

### CROSS-REFERENCE TO RELATED APPLICATIONS

The entire contents of Taiwan Patent Application No. 102128008, filed on Aug. 5, 2013, from which this application claims priority, are incorporated herein by reference.

### BACKGROUND OF THE INVENTION

1. Field of the Invention

The disclosure generally relates to a display device, and more particularly to a touch screen with a decoration layer.

2. Description of Related Art

A touch screen is an input/output device that utilizes sensing technology and display technology, and is widely used in electronic devices, particularly portable and handheld electronic devices. FIG. 1 shows a lateral cross-sectional view of a conventional touch screen 100. The touch screen 100 includes a liquid crystal module (LCM) 11 and a touch panel (TP) 12, which are bonded to a color glass (CG) 14 via an optically clear adhesive (OCA) layer 13.

The number of functions typically provided by such touch screens 100 is increasing, and the performance of these touch screens 100 is continually being enhanced. As the touch screen 100 is usually manufactured in mass production from elements to assembly, the touch screen 100 commonly lacks decoration. Users may add on a cover (not shown) with decoration pattern, which, however, increases cost and weight/volume, against the trend towards less in cost and weight/volume.

Some touch screens 100 devise a little decoration pattern, for example, by coating black matrix (BM) in boundary areas in the touch panel 12 of the touch screen 100 with little effect. As the boundary area of modern touch screens 100 tends to be reduced due to improvements in technology, space for decoration becomes more limited.

For the foregoing reasons, a need has arisen to propose a novel display device (e.g., touch screen) with more decorative pattern than the conventional touch screen 100, without incurring cost and weight/volume and without affecting functionality of the display device.

### SUMMARY OF THE INVENTION

In view of the foregoing, it is an object of the embodiment of the present invention to provide a display device with a decoration layer, which may be irradiated by ambient light to reveal a decorative pattern when the display device is not in operation, and which may appear to be transparent without interfering with what is displayed on the display device when it is in operation.

According to one embodiment, a display device includes a display module and a decoration layer that is at least formed in at least a portion of a view area. When the display module operates to emit light through the decoration layer, the decoration layer appears to be transparent. When the display module does not operate, the decoration layer is irradiated by ambient light to reveal a decorative pattern of the decoration layer.

### BRIEF DESCRIPTION OF THE DRAWINGS

FIG. 1 shows a lateral cross-sectional view of a conventional touch screen;

FIG. 2A shows a lateral cross-sectional view of a display device according to a first embodiment of the present invention;

FIG. 2B shows a lateral cross-sectional view of a display device according to a modified first embodiment of the present invention;

FIG. 3 shows an exemplary top view of the display device;

FIG. 4A shows a lateral cross-sectional view of a display device according to a second embodiment of the present invention;

FIG. 4B shows a lateral cross-sectional view of a display device according to a modified second embodiment of the present invention;

FIG. 5 shows an exemplary electrode layer of the touch module of FIG. 4B;

FIG. 6A shows a lateral cross-sectional view of a display device according to a third embodiment of the present invention;

FIG. 6B shows a lateral cross-sectional view of a display device according to a modified third embodiment of the present invention; and

FIG. 6C shows a lateral cross-sectional view of a display device according to a modified third embodiment of the present invention.

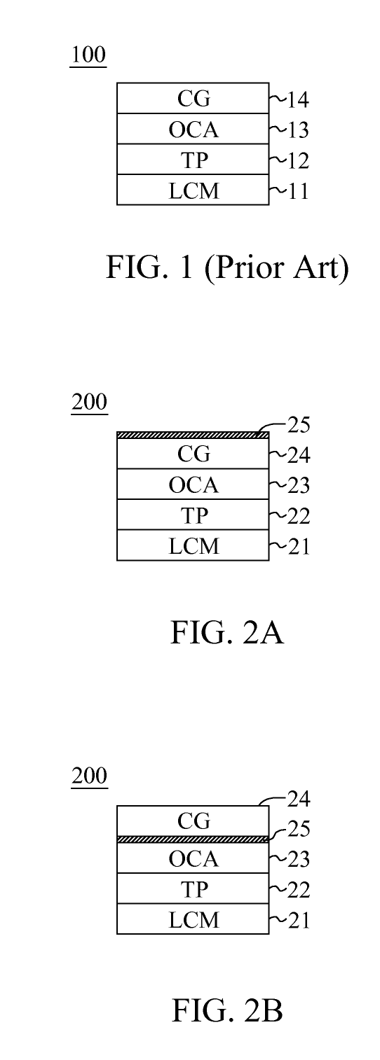

### DETAILED DESCRIPTION OF THE INVENTION

FIG. 2A shows a lateral cross-sectional view of a display device 200 according to a first embodiment of the present invention. A touch screen is exemplified in the following embodiments. However, the invention may be adapted to a display device without touch function.

For better understanding the embodiment, only primary structure is illustrated in the figures. More layers may be further added between or on top/bottom of the shown layers when required for specific applications. In the specification and drawings, direction “above” or “top” is directed toward a touch surface, and direction “below” or “bottom” is directed away from the touch surface.

In the embodiment, the display device 200 includes, from bottom to top, a display module (e.g., a liquid crystal module (LCM)) 21, a touch module (e.g., a capacitive touch panel (TP)) 22, an optically clear adhesive (OCA) layer 23 and a cover layer (e.g., a cover glass (CG)) 24. The display modules 21 and the touch module 22 mentioned above may be implemented by a variety of conventional or modern structures, and their details are omitted for brevity.

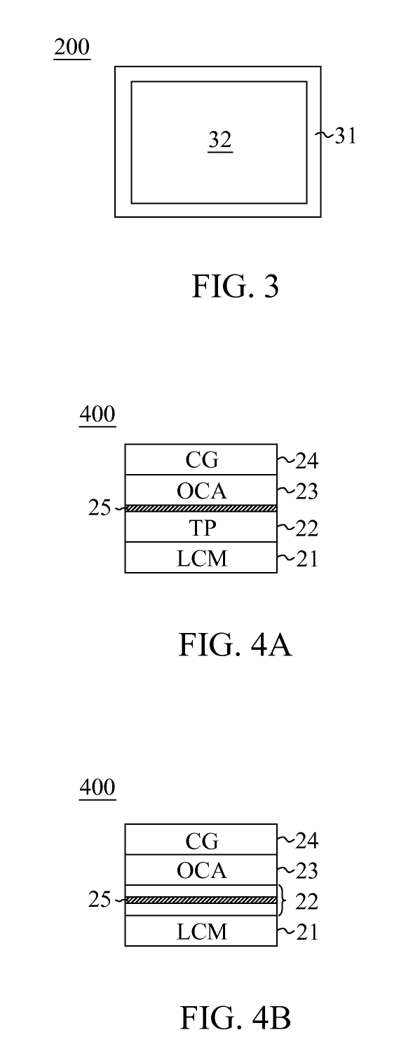

According to one aspect of the embodiment, the display device 200 further includes a decoration layer 25 disposed above the cover layer 24. FIG. 2B shows a lateral cross-sectional view of a display device 200 according to a modified first embodiment of the present invention, the decoration layer 25 of which is disposed below the cover layer 24. In the embodiment, the decoration layer 25 may be formed on an entire top or bottom surface, including a border area (BA) 31 and a view area (VA) 32, of the cover layer 24, as exemplified in a top view of the display device 200 in FIG. 3. The decoration layer 25, however, may be formed only on the view area 32 or a portion of the view area 32. Generally speaking, the decoration layer 25 of the embodiment may be at least formed in at least a portion of the view area 32.

The decoration layer 25 of the embodiment may include metal-based nanowires, metal-based microwires, metal-based nano particles, metal-based micro particles or metal-based micronet. In the embodiment, “metal-based” may be referred to metal (e.g., silver) or metal oxide (e.g., silver oxide). The decoration layer 25 of the embodiment includes decoration pattern, which may be formed by photolithography etching.

As the metal-based wires/particles/net of the decoration layer 25 have a diameter in a nanometer order (i.e., a few nanometers to hundreds nanometers) or a micrometer order (i.e., a few micrometers to hundreds micrometers), they are unobservable to human eyes. Accordingly, when the display module 21 operates to emit light through the decoration layer 25, the decoration layer 25 appears to be transparent without interfering with what is displayed on the display module 21.

When the display module 21 does not operate, that is, not emitting light, the decoration layer 25 may be irradiated by ambient light to reveal the decoration pattern of the decoration layer 25. To be specific, as the nano- or micro-wires/particles/net of the decoration layer 25 have haze difference, the decoration pattern of the decoration layer 25 may be revealed due to refraction and/or scattering of the ambient light in diverse directions.

FIG. 4A shows a lateral cross-sectional view of a display device 400 according to a second embodiment of the present invention, in which the reference numbers of the first embodiment are continuously used in the present embodiment. Compared with the first embodiment, the decoration layer 25 of the present embodiment is disposed above the touch module 22, or, alternatively speaking, disposed between the OCA layer 23 and the touch module 22. The formation, the structure and revealing principle of the decoration layer 25 are the same as the first embodiment, and their details are omitted for brevity.

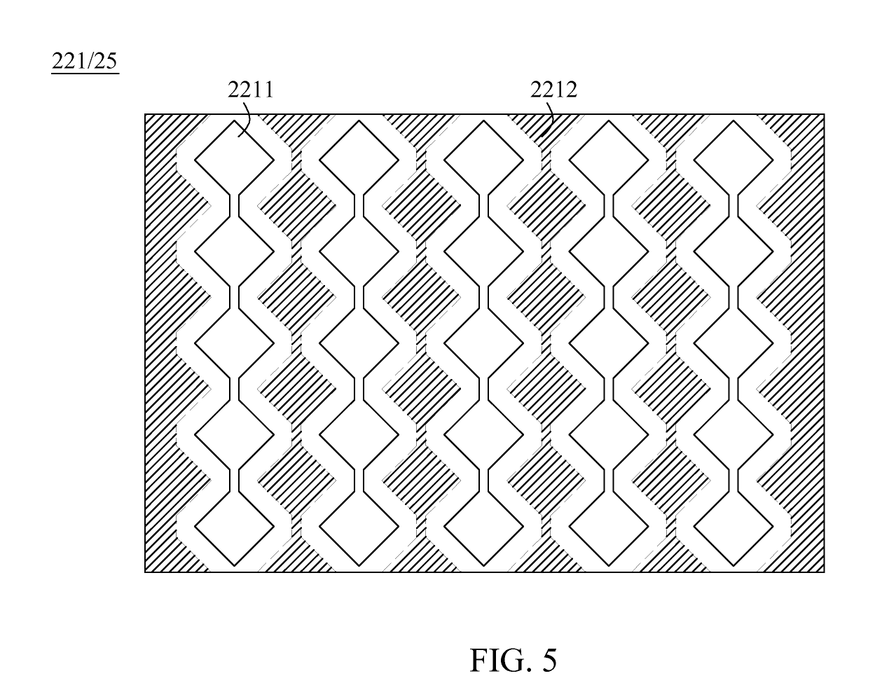

FIG. 4B shows a lateral cross-sectional view of a display device 400 according to a modified second embodiment of the present invention, the decoration layer 25 of which is disposed in the touch module 22, for example, disposed on an electrode layer of the touch module 22. FIG. 5 shows an exemplary electrode layer 221 (e.g., a transmit (TX) or a receive (RX) electrode layer), which also serves as the decoration layer 25 in the embodiment. The electrode layer 221 may include metal-based nano- or micro-wires, metal-based nano- or micro-particles or metal-based micronet. The electrode layer 221 may include electrode lines 2211 that are disposed in parallel. The decoration pattern may be formed on area (as indicated by slant lines) excluding the electrode lines 2211.

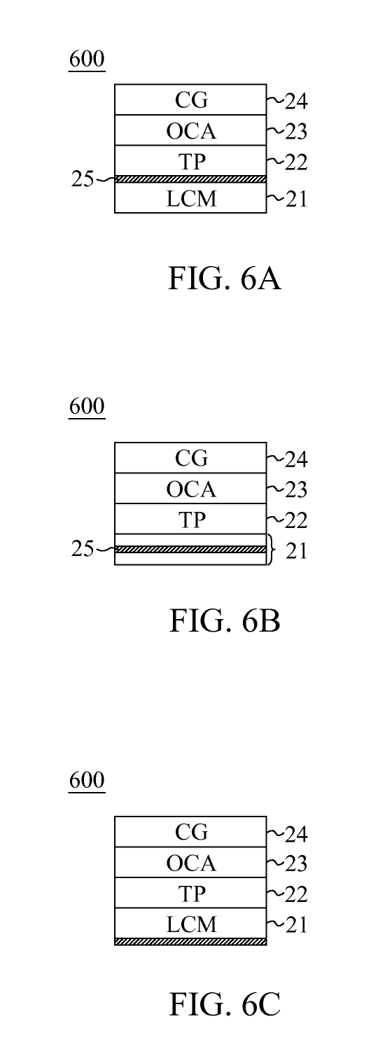

FIG. 6A shows a lateral cross-sectional view of a display device 600 according to a third embodiment of the present invention, in which the reference numbers of the first embodiment are continuously used in the present embodiment. Compared with the first embodiment, the decoration layer 25 of the present embodiment is disposed above the display module 21. The formation, the structure and revealing principle of the decoration layer 25 are the same as the first embodiment, and their details are omitted for brevity. FIG. 6B shows a lateral cross-sectional view of a display device 600 according to a modified third embodiment of the present invention, the decoration layer 25 of which is disposed in the display module 21.

FIG. 6C shows a lateral cross-sectional view of a display device 600 according to a modified third embodiment of the present invention, the decoration layer 25 of which is disposed below the display module 21. Assume the display module 21 is a transparent structure, the decoration layer 25 may be irradiated by ambient light to reveal the decoration pattern of the decoration layer 25, when the display module 21 does not operate. Alternatively, assume the display device 600 may emit light in both directions, that is, the display module 21 emits light upward and downward, the decoration layer 25 may be irradiated by ambient light to reveal the decoration pattern of the decoration layer 25 from the bottom surface of the display device 600, when the display module 21 does not operate.

Although specific embodiments have been illustrated and described, it will be appreciated by those skilled in the art that various modifications may be made without departing from the scope of the present invention, which is intended to be limited solely by the appended claims.

What is claimed is:

1. A display device, comprising:
a display module; and
a decoration layer being at least formed in at least a portion of a view area;
wherein when the display module operates to emit light through the decoration layer, the decoration layer appears to be transparent; when the display module does not operate, the decoration layer is irradiated by ambient light to reveal a decorative pattern of the decoration layer.

2. The display device of claim 1, further comprising:
a touch module disposed above the display module; and
a cover layer disposed above the touch module.

3. The display device of claim 2, further comprising an optically clear adhesive (OCA) layer disposed between the touch module and the cover layer.

4. The display device of claim 1, wherein the decoration layer is further formed in a boundary area.

5. The display device of claim 2, wherein the decoration layer is disposed above or below the cover layer.

6. The display device of claim 1, wherein the decoration layer comprises metal-based nanowires, metal-based microwires, metal-based nano particles, metal-based micro particles or metal-based micronet.

7. The display device of claim 6, wherein the metal-based is referred to metal or metal oxide.

8. The display device of claim 1, wherein the decoration pattern of the decoration layer is formed by photolithography etching.

9. The display device of claim 2, wherein the decoration layer is disposed above the touch module.

10. The display device of claim 2, wherein the decoration layer is disposed in the touch module.

11. The display device of claim 10, wherein the decoration layer is formed on an electrode layer of the touch module, the decoration pattern being formed on area of the electrode layer excluding the electrode lines.

12. The display device of claim 1, wherein the decoration layer is disposed above, below or in the display module.
